(19) United States
(12) Patent Application Publication
(10) Pub. No.: US 2025/0259069 A1
(43) Pub. Date: Aug. 14, 2025

(54) SYSTEMS AND METHODS FOR SECURE, SEGREGATED REVERSIBLE MACHINE LEARNING AI

(71) Applicant: First Draft Law, Inc., Lawrence, KS (US)

(72) Inventors: Robert E. Litan, Lawrence, KS (US); Mark C. Stephens, Crozet, VA (US); Teri Marlene Prince, Pinehurst, NC (US)

(21) Appl. No.: 19/000,531

(22) Filed: Dec. 23, 2024

Related U.S. Application Data
(60) Provisional application No. 63/613,441, filed on Dec. 21, 2023.

(51) Int. Cl. G06N 3/0895

(52) U.S. Cl. CPC G06N 3/0895

(57) ABSTRACT

A replicable and attributable AI framework ecosystem is presented. In embodiments, a set of processes, methods and apparatuses for secure, time-stamped, permission-based, segregated, reversible, private and community, machine learning artificial intelligence implementations, platforms and frameworks may be provided. In embodiments, a given process may include a series of discrete sessions, each labelled with a unique Universal Prompt Descriptor (UPD). The UPD allows each session to be reconstituted to its exact state at any subsequent time point. In embodiments, the AI framework ecosystem may be further configured to include timestamped logging, and, through AIRBOX analytics, determine authorship, and assign or limit responsibility.

### CROSS REFERENCE TO RELATED APPLICATIONS

This application claims the benefit of U.S. Provisional Patent Application No. 63/613,441, filed on Dec. 21, 2023 and entitled “SYSTEMS AND METHODS FOR SECURE, SEGREGATED REVERSIBLE MACHINE LEARNING ARTIFICIAL INTELLIGENCE IMPLEMENTATIONS,” the entire disclosure of which is incorporated herein by this reference.

### TECHNICAL FIELD

The present invention relates to artificial intelligence, and to systems, methods and apparatuses that implement secure, time-stamped, permission-based, segregated, private and community, reversible, Artificial Intelligence (AI)/Machine Learning (ML) platforms and frameworks.

### BACKGROUND

The year 2023 may be known as the Wild West for Generative AI—a lawless and unruly frontier, lacking rules, regulations, and guidance, with stratospheric hoopla for AI output upon which the AI user cannot depend. Without documentation and evidence of how Generative AI does what it does, what it started with and from whom and when, much less: (i) how to monitor and regulate its behavior, (ii) how to provide an audit trail of access, creation and modification, or (iii) how to improve performance and mitigate risk, AI output is the generated reality of our current world—a word/phrase prediction machine world, from unknown sources, where writers do not write, creators do not create, teachers do not teach, doctors do not treat, and lawyers do not provide legal advice.

Worse still, Generative AI is inherently insecure. The very process of training LLMs and imbuing them with added data and knowledge for fine-tuning and making more pointed queries churns confidential customer data and intellectual property (IP) back into the updated LLM, stealing, forever that unlicensed data—with no boundaries—amending, corrupting, hallucinating, or generating inaccurate, misleading, or dangerous results. In the journal Science (Dec. 5, 2023), scientists set out their concerns that “μl-informed use of artificial intelligence is driving a deluge of unreliable or useless research” and “in biomedicine, misclassification that could be a matter of life and death.”

For these reasons alone, Generative AI—no matter how powerful—is inappropriate for use with confidential or evidentiary information. Accordingly, the risks and flaws associated with AI have led directly to calls for taming this modern wild-west—reining it in with regulation and governance, and penalties for unsafe AI, and errors, and misuse.

To date, AI and LLMs have brought pseudo-human ability to write and opine on many topics. However, this ability, while appearing to be creative and honest, is statistically driven (without disclosure of the construct of the testing process and the underlying population), and data, user, creator, time, jurisdiction, and reality dependent. While LLM performance can vary from brilliant to catastrophic, to date it has been neither a triumph of logic nor of knowledge, because LLM results are not replicable, attributable, or reliable. AI's and LLMs, trained on public “data lakes,” such as, for example, the “open” Internet, are susceptible to the data errors floating in those lakes and the pollution that is added from sources both known and unknown. With some—or even most—data and information in the public domain neither verified, attributable, nor time-stamped, AIs/LLMs have not been built to assign input and output responsibility, such as who used what sources, from where, and when?

With fast iterative processing and software built to learn automatically, AI inputs and outputs are in an ever-growing state, without bills of materials, attribution, and provenance (people, goods, processes, jurisdictions), and without being backed and enhanced by actual knowledge and professional logic before entering the public domain. Initial AI states, and what is inferred from them, are either not disclosed or unknown, and assigning responsibility for AI output could slow down the AI engine or provide discoverable evidence of errors in fact and/or inference. Additional problems are created when AI's are trained, without proper attribution or at least an ability to provide compensation, on IP-protected customer IP.

Similarly, generative AI is usually performed through a chat interface, which is a very casual interaction between user and data. The user asks the LLM for answers but does not usually specify (or even being able to specify) the nature or quality of data to be used in the answer. Is it the truth or is it a rumor or just plain false? What is the source of this information? What reasons are there to believe it? These data types can be included in any record or log of the query and answer, and, indeed, should be. But GenAI still is not that well thought out yet.

What is needed are systems and methods that address these inherent problems of the prior art.

### SUMMARY OF THE INVENTION

Various embodiments of the present disclosure may be referred to herein as “AIRBOX.”

In embodiments, AIRBOX is the functional equivalent of an air gap computer implemented in a cloud, networked, or in an on-premises software or hardware environment. Added to this functional equivalence are logging, analytics, and software- and data-updating methods specifically configured to keep both the LLM and its inputs and outputs secure yet current.

An air gap computer is a physical computing device that functions without data connections to any private or public network, thereby remaining secure against hacker attacks and usable only in person by an authorized individual. In the case of AIRBOX, a platform within its own authorization boundary, the equivalent air gap computer is built entirely of software within a software container environment, accompanied by all software dependencies required to run. AIRBOX is further implemented by a platform within its authorization boundary with a permission engine front end for controlling user access and access to the AIRBOX, and permission layers to the hierarchy of access to all required support applications, including data logging, analytics, and software updating.

Some AIRBOX data input functions may be read-only, while logging and archiving may be write-only. However, and most importantly, the entire AIRBOX platform environment may be shut down at the end of each session and replaced with an entirely new platform at the beginning of the next session. But, importantly, deletion does not mean “gone in the sense of disappeared.”

What is gone is the environment. Each new session is a new environment—a fresh runtime module or platform.

What is not gone is the multi-dimensional matrix of the AIRBOX session logs (analogous to the World Wide Web's Universal Resource Locator (URL)) for every logged LLM event). Thus, in embodiments, to facilitate tracking of each AIRBIOX session, a Universal Prompt Descriptor (UPD) may be defined and utilized. In addition to time of session, in embodiments, the UPD may define the task, data and component software parts down to version numbers and permutations, state, options, extras and participants. Data may be further defined by type, origin and ownership. This is how, in embodiments, tasks may be reversed and participants may be allowed to keep (or at least keep beneficial ownership of) their data. In embodiments, the UPD is key to AIRBOX; it allows a given AIRBOX session to be reconstructed in its exact state at any point in the future.

Thus, in embodiments, any AI equipped with AIRBOX may facilitate compliance with future AI legal and regulatory requirements. This is useful in helping users avoid or minimize legal liability for uses and misuse of AI, as well as to facilitate the assignment of IP to contributions of users and other parties who bring their own data lakes to the training and use of AI engines.

Every new wave of technology brings with it a new level of mystery that takes time to overcome. Criminals and pornographers are typically at the crest of these waves, taking advantage before the larger population catches on. In this sense, what these new technologies come to be viewed as are black boxes. How does AI actually work over the long term? Nobody knows. Hence it is a block box. However, an AIRBOX is not a black box—it is transparent. For the first time, through AIRBOX, transparency (and audibility, reversibility and provenance) may be brought to an emerging technical wave.

Another feature of AIRBOX is to keep both customer data and intent from being fed back to an AI vendor software model, which is normally the automatic recipient of both types of information. In embodiments, AIRBOX users do not provide any data that furthers the growth or education of the host LLM. Conversely, by loading a fresh copy of the most recent LLM version at the beginning of each session, AIRBOX and AIRBOX users do benefit from the inadvertent contributions of all other unwitting users. To put it succinctly—AIRBOX takes but does not give.

### BRIEF DESCRIPTIONS OF THE DRAWINGS

FIG. 1 illustrates an example AIRBOX as a secure AI Ecosystem platform in the cloud with external data sources coming from outside the authorization boundary with no return flow, according to an embodiment.

FIG. 2 illustrates an exemplary recursion process according to an embodiment.

FIG. 3 illustrates an example process flow for input processing and session establishment, according to an embodiment.

FIG. 4 illustrates an example process flow for a RAG process, according to an embodiment.

FIG. 5 illustrates an example process flow for response delivery and session management, according to an embodiment.

FIG. 6A illustrates a first portion of an alternate process flow for

FIG. 6B illustrates a second portion of the alternate process flow of FIG. 6A.

### DETAILED DESCRIPTION

In embodiments, various problems in the prior art may be addressed by adopting software best practices, such as provenance and bill of materials (where the software components came from), for example, in logs.

As described below, embodiments according to the present disclosure use segregated and secure environments, and auditable creation-modification processes. Thus, such embodiments result in AI technologies and deployments that combine safety with higher performance.

Public domain AI systems do not take responsibility for their actions. Providing answers that are factually incorrect, or generating false information but presenting it as truth, is known as “AI hallucination,” rather than AI error. However, surgeons who are hallucinating are not permitted to operate, and pilots who are hallucinating are not allowed to fly a plane. Thus, embodiments according to the present invention provide a consistent and risk-based process to prevent AI hallucinations. In one embodiment, legal writing AI software may be provided. In other embodiments, medical and pharmacological AI software may be provided. All of these examples are designed to be free of AI hallucination.

In some embodiments, limits may be placed on direct public output by sending all output through a (human) customer, while adding logic detection and documenting responsibility (who said what and when) as well as robust customer privacy and one-way data flow.

AI systems and LLMs are possible not only because of advances in software, but because they are the ultimate in crowd-sourced technologies. Public domain AIs are built and trained on all the knowledge, as well as the falsities or rank speculations, and even bad opinions of “expert publications” who have it wrong, available on the Internet's “data lake” or “crowd”—the extraordinarily and rapidly growing repository of content (text and data) that is available on millions of websites. Yet, for all the terabytes of data read by AI systems, only a small subset is used to generate answers and content. This is a feature called “prompt engineering” which finds its strength in limiting data. As one example, prompt engineering tells the LLM it is a “real estate appraiser with 30 years of experience” as opposed to a self-styled “guru” or “influencer.”

Prompt engineering has limits of its own, though. The fundamental problem with prompt engineering is that it removes information rather than adding it and asks the LLM to pretend to be someone it may not know the attributes of at all. Such as, for example, “you are a real estate appraiser with 30 years of experience.” What does that mean in practice? How much knowledge must an LLM have to engage in such “pretend” scenarios? Prompt engineering, which is a form of no code programming, has changed the way we interact with computers.

While a human writer always knows more than they can write about their subject, LLMs know less, and invent the rest. We call this missing data dark matter because it makes up most of the symbolic systems universe.

In some embodiments, the available knowledge base may be expanded by maintaining a common database and LLMs trained for use by all customers, as well as a private database, and privately trained LLMs for proprietary customer-specific data. Thousands of customers would mean thousands of such customer virtual private clouds. Data flows into the general use LLM and database, and then flows into the customer LLM and database, so that the customer model can be updated and upgraded without any data back flow. This maintains both customer confidentiality, and secure customer intellectual property.

AI is too big, powerful, influential, and popular to be outlawed or regulated to death. AI providers and users must find effective ways to make AI secure (and capable of providing proper attribution), as well as able to comply with the rule sets, and legal and regulatory environments that will inevitably be developed for customer IP used to build and modify it. Indeed, rule sets and legal rules and regulations seem to be on the immediate horizon. Consider the rapid movement from the January 2023 NIST Artificial Intelligence Risk Management Framework (AI RMF 1.0)—a “voluntary” “resource”—“to help . . . promote trustworthy and responsible development and use of AI”, to the following developments all within the same year: the Dec. 9, 2023 announcement of the “Artificial Intelligence Act”; and provisional agreement of the EU Council and Parliament for harmonized rules, draft regulations and penalties to ensure that AI systems in the EU market “include safeguards on the use of AI”, leading to development of a “legal framework for the development of AI you can trust.” In what follows, such an AI system may be referred to as an “AI Framework Ecosystem.”

Responding to such concerns, in embodiments, a combination of systems, methods and apparatuses for a replicable and attributable AI Framework Ecosystem—specifically secure, time-stamped, permission-based, segregated, reversible, private and community, machine learning artificial intelligence implementations, platforms and frameworks is herein described.

In embodiments, reliable AI—truly professional AI—where the “Professional” has an underlying body of knowledge in a particular domain and continues to learn (life-long-learning) so that when errors are made, the professional recognizes and corrects the errors rather than pleading “hallucination” or “technical hiccup”—is facilitated. A further objective is to create a functional computing environment, which may be called “an AI Framework Ecosystem,” where Generative AI is secure and reliable, with a menu list of features and standards, for it to thrive.

The challenges here are huge. Not only must AI and ML remain secure for individual users or customers, but also for groups or federations of users or customers. With current AI/ML capabilities, a group who withdraws may have a legal right to take what they brought to the table with them.

In the legal domain, for example, when multiple law firms working together on a particular matter share information and materials, under current AI/ML capabilities, how do they separate materials and IP at the end of a case, or deal with one party to the litigation transferring to another law firm, or determine who is at fault when AI is used to generate a report or a conclusion that contains inaccuracies?

Or, for example, in the FinTech domain, with the sheer volume of applications and numbers of transactions, and the inability to correct past errors in the model and the data collected, how can one remove discriminatory past lending practices from AI credit decisions?

Or, for example, in the pharmaceutical domain, how can drug companies, doctors, hospitals, and government agencies cooperate on drug trials and other research yet retain the ability to take their property and go home? How do they ensure that confidential patient information has not been disclosed? How can they remove results that originate from physicians who have had their licenses revoked for malpractice, or the work of scientists who have been found to disregard research protocols? How can a commercial data provider maintain control of IP developed over years at costs in millions of dollars?

In embodiments, AIRBOX provides the answers to the above questions. This is done through the combination of its secure environment and the reversible nature of its abilities, and a complete set of secure, time-stamped, permission-based, segregated, reversible, private and community, machine learning artificial intelligence implementations, platforms and frameworks which comprise the AIRBOX Ecosystem.

In embodiments, four types of functions may be implemented in AIRBOX.

First, to address the underlying knowledge lake and its involvement in AI output for almost any purpose, a protective layer of logic and cross-testing may be added to the lucidity and inferences of LLMs. In embodiments, this diminishes risk and makes AI writing more accurate and attributable.

### BERTScores and Hallucination Detection

In embodiments, readability scores and BERTScores (explained below) may be leveraged to detect LLM hallucinations. In embodiments, this approach can, for example, be structured as follows:

1. Semantic Sieve with Parallel Tools:

Use multiple parallel AI tools to generate responses to the same input. For example, if three different LLMs (LLM1, LLM2, and LLM3) are used, each will produce its own version of the response.

### 2. BERTScore Calculation:

For each sentence in a response, calculate the BERTScore against the most similar sentence from each of the other parallel tool responses. BERTScores measure semantic similarity between sentences, providing a score between 0 and 1, where 1 indicates a perfect semantic equivalence.

### 3. Readability Score Integration:

Calculate readability scores for each sentence in the response using tools such as, for example, Flesch-Kincaid Grade Level or Gunning Fog Index. Readability scores help assess the clarity and simplicity of the language used.

### 4. Consistency and Hallucination Detection:

Determine the average BERTScore across all parallel tool responses for each sentence. If a sentence has an average BERTScore close to 1 across multiple tools, it may be considered factual and consistent. If a sentence has low or inconsistent BERTScores (e.g., below a threshold of 0.5) and high readability scores, it may indicate a hallucination or outlier.

### 5. OpTel Extensions Integration:

Build this logic into proprietary OpTel extensions to automatically flag and prioritize responses based on the criteria mentioned, and provide an interface for users to review flagged sentences and manually override if necessary.

Example Code Snippet:

```
python
from bert_score import score
import numpy as np
def calculate_bertscore(sentence, parallel_responses):
  scores = [ ]
  for response in parallel_responses:
    P, R, F1 = score([sentence], [response])
    scores.append(F1.numpy( )[0])
  return np.mean(scores)
def detect_hallucinations(parallel_responses, threshold=0.5):
  hallucinations = [ ]
  for i, sentence in enumerate(parallel_responses[0]):
    bertscore = calculate_bertscore(sentence, parallel_responses)
    if bertscore < threshold:
      hallucinations.append((sentence, bertscore))
  return hallucinations
# Example usage
parallel_tools_responses = [
  [“LLM1 response sentence 1”, “LLM1 response sentence 2”],
  [“LLM2 response sentence 1”, “LLM2 response sentence 2”],
  [“LLM3 response sentence 1”, “LLM3 response sentence 2”]
]
hallucinations = detect_hallucinations(parallel_tools_responses)
print(“Detected Hallucinations:”, hallucinations)
```

Such an exemplary approach provides a practical and scalable method for detecting LLM hallucinations by leveraging semantic similarity and readability scores. In embodiments, integration with OpTel extensions ensures that this logic may be easily applied to real-world scenarios, thereby enhancing the reliability and trustworthiness of AI-generated content.

Second, to correct for the flaws in AIs/LLMs trained on public domain data without guardrails, in embodiments, AIs/LLMs trained on data lakes licensed from independent data providers, as well as data lakes owned or controlled by organizations (private for-profit, private not-for-profit, and governmental) with the authority to provide this material, may be enabled. By enabling authorized users to specify in their initial settings—before using any AI/LLM—which data lakes and which prior versions are their starting point, and securing their environments, private data is kept private and uncorrupted. In embodiments, such entities may include virtual, digital, and/or real-world entities.

Enhanced Answer with Metadata Identifying Data Sources:

To correct for the flaws in AIs/LLMs trained on public domain data without guardrails, in embodiments, a multi-layered approach may be implemented that involves using licensed data from independent data providers and securing environments to ensure private data remains protected. In embodiments, such an approach may be structured as follows:

1. Data Lake Licensing with Metadata:

Enable the use of AI/LLMs trained on data lakes licensed from independent data providers and organizations (private for-profit, private not-for-profit, and governmental). The data lakes should have explicit guardrails to ensure compliance with privacy laws and ethical standards. Additionally, each dataset within the data lakes should be accompanied by comprehensive metadata identifying its origin, source, and age.

### 2. User-Specified Data Lakes and Versions:

Allow authorized users to specify in their initial settings which data lakes and prior versions may serve as the starting point for AI/LLM operations. This ensures that AI models are trained and used with controlled, vetted datasets tailored to each user's requirements. Metadata can be utilized to track the lineage of data, ensuring transparency and accountability.

Third, with users, data owners, and data, versioned and permissioned in an auditable manner, sources, attributions, and authorship may be, for example, managed at the activity level and forensically determined after-the-fact.

In embodiments, AIRBOX emphasizes a closed and controlled environment to minimize the risk of external data corruption. By implementing strict access controls, encryption protocols, and continuous monitoring, AIRBOX may further ensure that the integrity and confidentiality of its operations are maintained. OpTel trace logging, for example, may, for example, reveal when data or metadata have changed. Then it's a matter of turning attention to the next most recent UPD to see what just happened in case it was not already noticed when things were deliberately or inadvertently changed. This approach aligns with managing hallucinations and ensuring high-quality data within AI systems as disclosed herein. In embodiments, the closed nature of AIRBOX further mitigates potential issues related to external data corruption, providing a secure platform for processing and analyzing information. This is a matter of integrating a recursion loop in OpTel to detect not only what just happened, but also to understand what happened previously to make it happen.

3. Entity Inclusion with Metadata Identification:

In embodiments, for internal data, metadata may be used to indicate its origin as being internally sourced. For data passed through from third parties (e.g., customers or partners), metadata should identify both sources: the original provider and any intermediate handlers. In embodiments, data without clear metadata, or with suspect origins, may be removed or flagged for further scrutiny.

### Enhanced Logging:

Logging across all API endpoints to capture detailed information about data inputs, processing steps, and outputs. Structured logs may be used that include timestamps, entity types, metadata, and error codes.

In embodiments, centralized monitoring may be integrated with OpTel for real-time monitoring of system performance and health. Dashboards may visualize key metrics and identify anomalies or errors, while automated alerts for specific types of errors or unusual patterns may be used to provide clear instructions on how to investigate and resolve issues.

### Error Tracing Tools:

Existing error tracing tools may be used or further developed to help identify the root cause of errors, and a breadcrumb system may be implemented that tracks data flow through different components of the system.

### Automated Testing and Validation:

While not every piece of data need be validated, in embodiments automated tests for critical pathways may be used to ensure they function correctly. Unit tests, integration tests, and end-to-end tests may thus be used to catch errors early in the development cycle.

### Continuous Integration/Continuous Deployment (CI/CD) Pipelines:

CI/CD pipelines may be implemented that include automated testing and validation steps. This may ensure that any changes to the system are thoroughly tested before deployment.

By integrating the above described measures, in embodiments, the risks associated with AIs/LLMs trained on public domain data may be mitigated, and the trustworthiness of AI systems may be enhanced. In embodiments, comprehensive metadata management ensures that data integrity may be maintained throughout its lifecycle, from acquisition to deployment.

Third, with users, data owners, and data, versioned and permissioned in an auditable manner, sources, attributions, and authorship may be, for example, managed at the activity level and forensically determined after-the-fact.

Fourth, to further diminish risk, in embodiments, these functions may be, for example, encased and protected in highly secure environments. For example, one embodiment may be built on a Fedramp-certified integration platform as a service. Various embodiments may also run standalone in other secure environments and may, for example, be configured by those with the appropriate level of permissions per other jurisdiction appropriate cyber security standards.

Thus, in embodiments, various mechanisms may be provided for using responsible AI in any industry, non-profit or governmental setting that manages LLMs, protects customer data, provides robust logging and analytics to evidence what is happening inside the LLMs, and attribute ownership and blame (if necessary). In embodiments, multiple ways may be provided to add logic to lucidity, making AI better and more responsible in every way.

Further, various embodiments impose on any hosted AI or LLM a system of checks, balances and permissions derived from cybersecurity rules, reporting and practices, controlling data sources, outputs and destinations, and the flow of data through the system, keeping separate the IP of unrelated parties yet still allowing collaboration, and additions and reverses with all of these actions and permissions logged and auditable.

Various embodiments use segregated and secure environments, and auditable creation-modification processes. Thus, such embodiments result in AI technologies and deployments that combine safety with higher performance.

AI systems in the public domain do not take responsibility for their actions. Providing answers that are factually incorrect, or generating false information but presenting it as truth, has come to be called AI hallucination, rather than AI error. It is noted that surgeons who are hallucinating are not permitted to operate, and pilots who are hallucinating are not allowed to fly a plane. In embodiments, a consistent and risk-based process may be provided to prevent hallucinations in AI software. In one embodiment, legal writing “astute” AI software for the courtroom may be provided. In other embodiments, “astute” medical and pharmacological AI software may be provided.

In embodiments, limits may be placed on direct public output by sending all output through a (human) customer or user, while adding logic detection and documenting responsibility (who said what and when) as well as robust customer privacy and one-way data flow.

AI systems and LLMs are possible not only because of advances in software, but because they are the ultimate crowd-sourced technology. Public domain AIs are built and trained on all the knowledge, as well as all of the falsities, available on the Internet's “data lake” or “crowd”—the extraordinarily and rapidly growing repository of content (text and data) that is available on millions of websites. Yet, for all the terabytes of data read by AI, only a small subset is actually used to generate answers and content, a feature called “prompt engineering” which finds its strength in limiting data. As one example, prompt engineering tells the LLM it is a “real estate appraiser with 30 years of experience.”

But prompt engineering has limits of its own, which some embodiments hereof overcome. A fundamental problem with prompt engineering is that it removes information rather than adding information and asks the LLM to pretend to be someone it may not know the attributes of, such as, for example, “You are a real estate appraiser with 30 years of experience . . . ” What does that mean in practice? How much actual knowledge must an LLM have to engage in these sorts of “pretend” scenarios. Prompt engineering, which is a form of no code programming, has changed the way we interact with computers, and not always for the better.

While a human writer always knows more than they can write about their subject, LLMs actually know less, and invent the rest. We call this lost data dark matter because it makes up most of the symbolic systems universe.

In some embodiments, an available knowledge base may be expanded by maintaining a common database and LLMs trained for use by all customers, as well as a private database, with privately trained LLMs for proprietary and customer-specific data. Thousands of customers would mean thousands of such customer specific virtual private clouds. In embodiments, data flows into the general use LLM and database, and then, afterwards, flows into the customer LLM and database, so that the customer model can be updated and upgraded without any data backflow. This is to maintain customer confidentiality, and secure customer intellectual property.

In one embodiment, an AIRBOX Ecosystem may be an integration Platform as a Service (iPaaS) configuration of the FedRAMP/NIST SP 800-53 (Rev 4), credentialed CLASsoft™ Platform as a Service (PaaS), all at the same credentialed AWS location, US East Infrastructure as a Service (IaaS).

In embodiments, an AIRBOX Ecosystem may be, for example, secured within a double authorization boundary, for complete separation of AIRBOX Session(s) from its own and the CLASsoft™ PaaS authorization boundary, and the AI engine and the data lake from the per client/project objectives, requirements, and the cybersecurity rules and standards, and:
Registrations, Applications, Claims, Cases, Files
Persons, Objects, Events, Organizations, Entities
Data, Documents, Forms, Communications
Relationships, Requirements, Regulations
Operations, Processes, Protocols
Workflow, Permission Hierarchies, Administration; and
Reporting, Auditing, Archiving.

In embodiments, as per NIST 800-53 Rev 4, the complete flow of data in and out of an AIRBOX Ecosystem's authorization boundary may be controlled. Protections may be implemented at all entry and exit points in the data flow as well as internal controls between “customer” and “owner/project” users. Data flows for privileged and non-privileged authentication/authorization to the platform for internal and external users may be documented.

In embodiments, at a minimum, the following security controls may be enforced to ensure the security and integrity of the PaaS/iPaaS cybersecurity and logging processes:
Access Control, Account Management, Access Enforcement, Information Flow Enforcement, Separation of Duties, Least Privilege, Unsuccessful Logon Attempts, System Use Notification, Concurrent Session Control, Session Lock, Session Termination;
Permitted Actions Without Identification or Authentication, Remote Access, Wireless Access, Access Control For Mobile Devices;
Use of External Information Systems, Information Sharing, Publicly Accessible Content;
Audit and Accountability Policy and Procedures, Audit Events, Content of Audit Records;
Audit Storage Capacity, Response to Audit Processing Failures, Audit Review, Analysis and Reporting, Audit Reduction and Report Generation; and
Time Stamps, Protection of Audit Information, Non-repudiation, Audit Record Retention, Audit Generation.

With inherited controls from CLASsoft™ as PaaS and AWS as IaaS, in embodiments, an example AIRBOX ecosystem may demonstrate compliance with NIST 800-53/FedRAMP, and its built-for-compliance and built for-cybersecurity framework structure RegTech, FinTech, InsureTech, HealthTech, LegalTech, DefenseTech application and use cases.

In embodiments, inside the authorization boundary, AIRBOX may provide a fully functional software computing platform environment, including firewalls, functional LLM, customer data and query state information as well as all dependencies: logging, analytics, and limited access capability. LLM data may, for example, be read-only while logging and analytics data may be write-only beyond the software container. There is no firm limit on the number of interoperating modules running within the container, which can be dynamically resized to cope.

In embodiments, an AIRBOX may be built for secure platform-to-platform interconnections/external services as per the NIST 800-53 definition: “a system service that is implemented outside of the authorization boundary of the organizational system (i.e., a service that is used by, but not a part of, the organizational system) and for which the organization typically has no direct control over the application of required security and privacy controls or the assessment of security and privacy control effectiveness.”

In embodiments, iPaaS (interconnection platform-as-a-service) and CLASsoft™ as PaaS (platform-as-a-service) and AWS as IaaS (infrastructure-as-a-service) and AIRBOX as PaaS, may be used with definitions, authorization boundaries, inherited controls and cybersecurity risk and compliance per NIST 800-53/FedRAMP, for the AIRBOX AI Ecosystem Framework. This ensures “a set of cybersecurity activities, outcomes and informative references that are common across sectors” and a design, from the start, to “align and prioritize cybersecurity activities with business/mission requirements, risk tolerances and resources.”

In embodiments that are NIST 800-53/FedRAMP compliant as per the FedRAMP Act of December 2022, the AIRBOX AI Ecosystem Framework meets the U.S. cybersecurity standard for cloud solutions to the level of controlled unclassified. Informed by the October, 2023 SEC charges against SolarWinds Corporation and its information security “for fraud and internal control failures relating to allegedly known cybersecurity risks and vulnerabilities” per NIST 800-53 standards, in embodiments an AIRBOX AI Ecosystem Framework meets SEC standards as well as the de facto cybersecurity standard for governments allied with the US in military (NATO) and intelligence (Five Eye Nations), and best practice cybersecurity in purely private sector settings, in dealing with customers and suppliers.

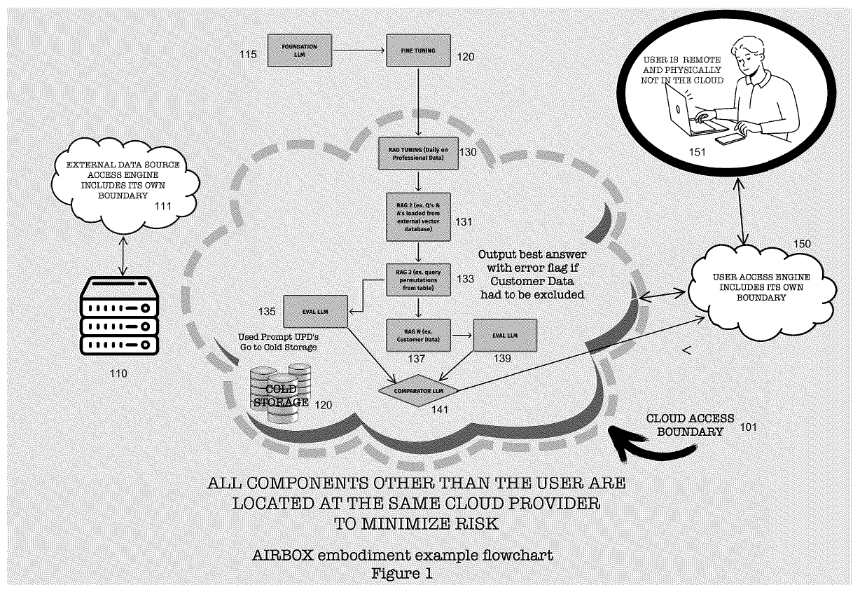

Next described with reference to FIGS. 1-5 is an example AIRBOX secure ecosystem, and an example recursion process through which an example AIRBOX may, in embodiments, detect errors or improper changes and take appropriate action.

FIG. 1 illustrates an exemplary AIRBOX embodiment, which is a secure AI ecosystem platform in the cloud. The AIRBOX has external data sources 110, which are accessed via external data source access engine 111, and which come from outside the cloud access authorization boundary 101, without return flow. External data source access engine 111 has, as shown, its own boundary.

Continuing with reference to FIG. 1, cloud access boundary 101 is shown as a dashed curve in the shape of a cloud. Processing may begin, for example, at LLM 115, which may draw data, for example, from one or more external data sources 110. LLM 115 may process the data, and then, for example, provide output to fine tuning block 120. Block 120 fine tunes the received output, which may then be imported through cloud access boundary 101 and input to RAG tuning 130. From RAG tuning 130, the output may be further processed by a set of RAG modules RAG 2 131, RAG 3 133, . . . , RAG N 137. Thus, as shown, the data may be refined inside the authorization boundary 101 using LLMs of various types including, for example, GPT, MLM and seq2seq, for purposes that include responding to prompts, evaluating text, answering questions, drafting documents and other purposes.

In the depicted example, the RAG (N−1)th module happens to be RAG 3, but RAG N−1 could be, for example, any Mth RAG module, where M<N. As shown, two or more alternate outputs may be generated, such as, for example, that from RAG 3 133 and that from RAG N 137, and these outputs may be separately evaluated at EVAL LLM 135, and EVAL LLM 139, respectively. Both (or multiple, if outputs of earlier RAG modules are also separately generated), are then processed at COMPARATOR LLM 141. This multiple-tap process allows the best answer to be obtained and output to a user, with an error flag if the best answer had to exclude some data, as shown. A final answer may then be sent to user access engine 150, which includes its own boundary, and then passed to user 151.

As further shown in FIG. 1, during data flow through the system, safety points may be saved to cold storage 120 based on their UPD at that stage of processing. As noted, prompt permutations may be, for example, compared and contested, and the customer 151 may eventually be presented with an output choice between, for example, one based on company data and one based on, for example, all data except for the company data. (Other exclusions of data, obtained from tapping the output flow at an earlier (upstream) RAG module may also, for example, be evaluated.) In response, a customer 151 or user makes the choice, and is then responsible for any output subsequently released to the wild. Finally, as shown in FIG. 1, user 151 may be remote, and physically not in the cloud.

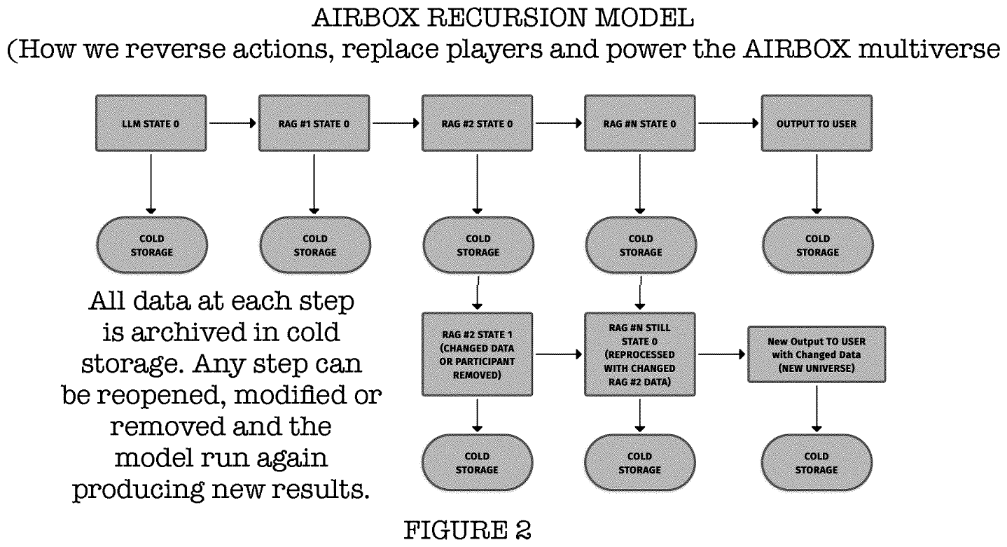

FIG. 2 illustrates an example AIRBOX recursion process through which an AIRBOX may detect errors or improper changes and/or eliminate completely players and data from the prompt authorship. In embodiments, at each processing stage (for example, at LLM STATE 0, RAG #1 STATE 0, RAG #2 STATE 0, RAG #3 STATE 0, . . . , RAG #N STATE 0) a unique UPD may be sent, for example, to Cold Storage (encrypted remote storage with delayed retrieval—making it less expensive). In embodiments, each UPD may be marked with a unique checksum generated from its contents. In embodiments, the checksums may be periodically surveyed and compared to their original values and any that have changed may be tagged as suspect. Repairs, changes, or elimination of participant data may then be done by reverting the prompt to any interim (i.e., earlier or upstream) processing point UDP where the paths can diverge with the creation of a new result, an alternate reality and an effectively changed universe. This is shown in FIG. 2, for example, as “OUTPUT TO USER” and “New Output TO USER with Changed Data.” In embodiments, both universes are preserved as evidence making any changes detectible and reversible even back to State Zero—its exact state before any changes were made or prompts generated.

As shown, in embodiments all data at each step in the processing may be archived in storage. Further, any step may be reopened, modified or removed, and the model run again producing new results.

While FIG. 2 illustrates the generation of two universes, it is understood that, in general, with RAG #N states, multiple alternate states may be used, and thus, multiple alternate outputs to user may be generated and presented to the user. Thus FIG. 2 is understood as being exemplary, but not limiting.

In various embodiments, in terms of an AIRBOX as an intelligent AI engine, the following is noted:

An example AIRBOX is an intelligent AI input processor moving the underlying model from [Input State (0), Output State (0)] to [Input State (1), Output State (1)]

An example AIRBOX is an intelligent AI input processor moving the underlying model from [Input State (K), Output State(K)] to [Input State(K+1), Output State (K+1)]

An example AIRBOX is an intelligent AI reversal processor that restores the underlying model to its previous state, by in its entirety from [Input State (K), Output State(K)] to [Input State (K−1), Output State(K−1)].

An example AIRBOX is an intelligent AI reversal processor that moves the underlying model back to a prior “new” state, by removing a subset of the previous input and generating a new output [Input State (KK), Output State(KK)] to [Input State (KK+1), Output State(KK+1)].

In terms of AIRBOX as an Ecosystem, an Ecosystem as described herein may receive user input data and/or historical data from a number of sources, including but not limited to: third-party legal databases and applications (e.g., Westlaw®, Lexis Nexis®, etc.), government databases and applications, private data collections (e.g. a law firm file of briefs), community data collections (e.g. the files from a multi-firm complex litigation matter), and media databases and applications, archived historical records.

In terms of processing, in embodiments, in all cases, user-specific data may also be received from an application running locally on an electronic device.

In terms of independence, specifically, and fundamental to various embodiments, the processes, frameworks, systems and methods described herein are stage and state independent. Any specific process, system, or method is exemplary, and is understood not to limit the scope of any embodiment.

The processes, frameworks, systems and methods described herein are independent of the starting database; independent of the type or brand of AI/ML, AI/ML “tool” and objective and invention, for user type and starting data lake; and independent of operating system and cloud, and independent of the way the cloud is deployed—via the web, or on cloud hardware/infrastructure.

Although AWS and CLASsoft™ may be used in some of the descriptions above, and examples presented below, it is to be understood that the AIRBOX Ecosystem Framework is independent of the means of input (e.g., direct, batch upload, operating system) or type of device, and also independent of the front-end platform that controls and delivers the regulatory environment and the front-end platform.

Although NIST Special Publication 800-53, Revision 4 and FedRAMP, the Federal Risk and Authorization Management Program may be used in some of the descriptions above and examples below, it is to be understood that the AIRBOX Ecosystem Framework is independent of the particular set of Security and Privacy Controls of the Information System and the jurisdiction.

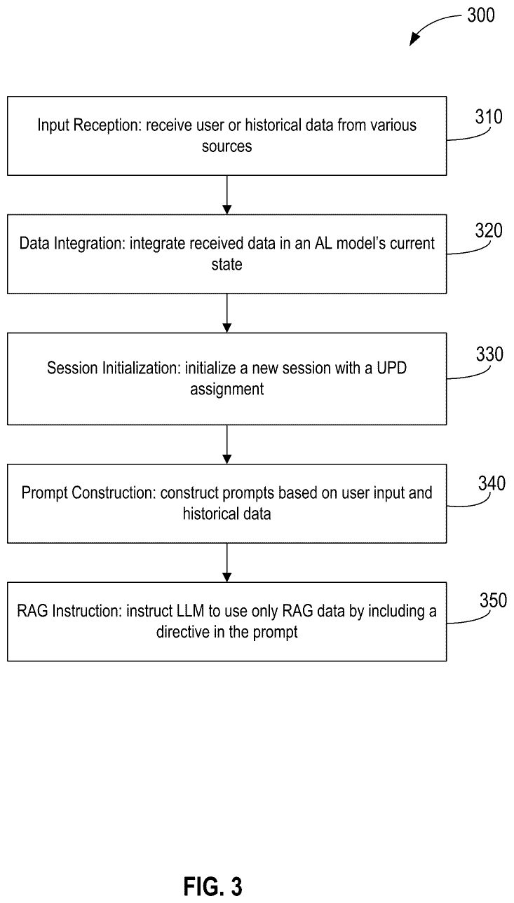

Next described are example process flows, with reference to FIGS. 3-5.

FIG. 3 illustrates an example process flow 300 for input processing and session establishment, in accordance with various embodiments. Process flow begins at block 310, Input Reception, where user input data or historical data is received from various sources. Process flow then moves to block 320, Data Integration, where the received data is integrated into the AI model's current state. Process flow then moves to block 330, Session Initialization, where a new session is initialized with a UPD assignment. From block 330, process flow then moves to block 340, Prompt Construction, where prompts are constructed based on the user input and historical data. Finally, from block 340, process flow then moves to block 350, RAG Instruction, where the LLM is instructed to use only RAG data by including a directive in the prompt.

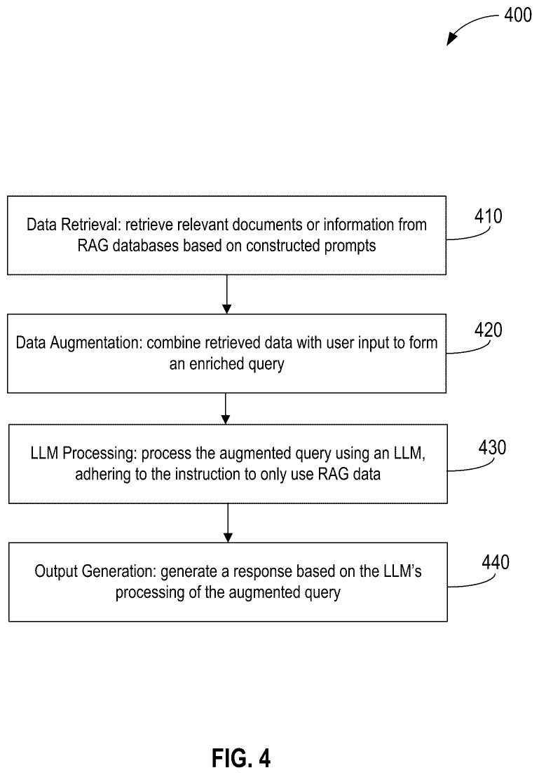

FIG. 4 illustrates an example process flow 400 for a RAG process, in accordance with various embodiments. Process flow begins at block 410, Data Retrieval, where relevant documents or information from RAG databases are retrieved based on the constructed prompts. Process flow them moves to block 420, Data Augmentation, where retrieved data are combined with user input to form an enriched query. From block 420 process flow moves to block 430, LLM Processing, where the augmented query is processed using the LLM, adhering to the instruction to use only RAG data. Finally, from block 430 process flow moves to block 440, Output Generation, where a response is generated based on the LLM's processing of the augmented query. Process flow ends at block 440.

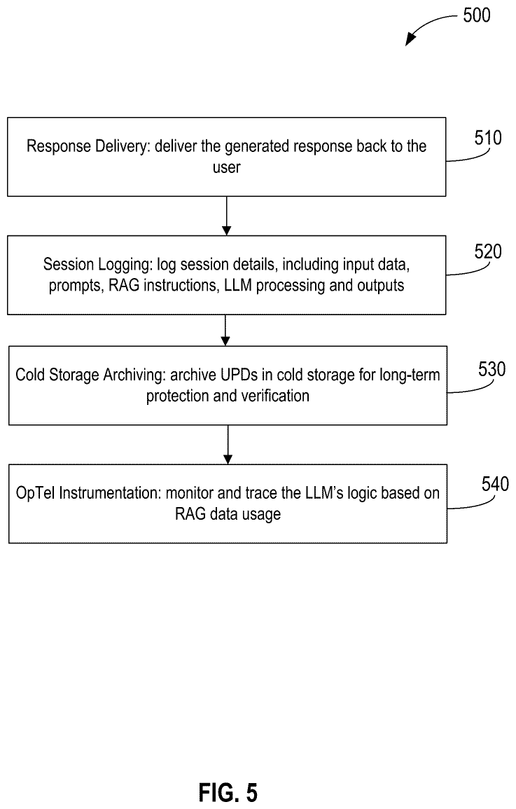

FIG. 5 illustrates an example process flow 500 for response delivery and session management, in accordance with various embodiments. Process flow begins at block 510, Response Delivery, where the generated response is delivered back to the user. From block 510, process flow moves to block 520, Session Logging, where the session details, including input data, prompts, RAG instructions, LLM processing, and outputs, are logged. From block 520, process flow moves to block 530, Cold Storage Archiving, where UPDs are archived in cold storage for long-term protection and verification. Finally, from block 530 process flow moves to block 540, OpTel Instrumentation, where OpTel instrumentation is used to monitor and trace the LLM's logic based on RAG data usage. Process flow ends at block 540.

In embodiments, another process flow may be implemented, similar overall to the process flows of FIGS. 3-5, but also dealing with an AI model's various state transitions as processing continues, including “reversal mode” functionality, as shown below:

### Initial Input Processing:

Input Reception: AIRBOX receives user input data or historical data from various sources (e.g., third-party legal databases, government databases, private data collections).
Data Integration: The received data is integrated into the AI model's current state, denoted as [Input State(0), Output State(0)].

### Session Establishment:

UPD Assignment: Each session of the AI Framework Ecosystem is assigned a unique UPD to facilitate exact reconstitution at any subsequent time.
State Transition: The model transitions from [Input State(0), Output State(0)] to [Input State(1), Output State(1)].

### Continuous Processing:

Iterative Input-Output Cycles: AIRBOX processes subsequent inputs, updating the model state iteratively from [Input State(K), Output State(K)] to [Input State(K+1), Output State(K+1)].
Logging and Timestamping: Each step is logged with timestamps for accountability purposes.

### Instruct LLM to Use Only RAG Data:

Prompt Modification: Before processing each input, modify the prompt to instruct the LLM to use only RAG (Retrieval-Augmented Generation) data.
State Transition: This step is part of the iterative input-processing cycle and modifies [Input State(K+1)] to ensure that it includes the instruction to use only RAG data.

### Reversal Mode Activation:

Data Reversal Trigger: When a reversal operation is initiated, AIRBOX moves the model back to a previous state.
Full State Restoration: In some cases, AIRBOX restores the model entirely from [Input State(K), Output State(K)] to [Input State(K−1), Output State(K−1)].
Partial Input Removal: In other scenarios, AIRBOX removes a subset of the previous input and generates a new output from [Input State(KK), Output State(KK)] to [Input State(KK+1), Output State(KK+1)].

### Security and Accountability:

Permission Management: Secure, permission-based access controls ensure that only authorized users can modify the AI model.
Authorship Analytics: AIRBOX determines authorship through analytics to assign or limit responsibility.
Data Protection: Features like reversible data changes and protection against upstream migration of data are implemented to maintain privacy and integrity.

### Compliance:

Jurisdictional Requirements: The AI Framework Ecosystem is designed to comply with jurisdictional rules and requirements in terms of privacy, cybersecurity, operations, and risk management.
Cold Storage Archiving: UPDs are archived in Cold Storage for long-term protection and verification.

### User Output:

Response Generation: After processing the input with the RAG instruction, AIRBOX generates a response based on the LLM's output.
Output Delivery: The generated response is delivered to the user as an answer to their question or request.

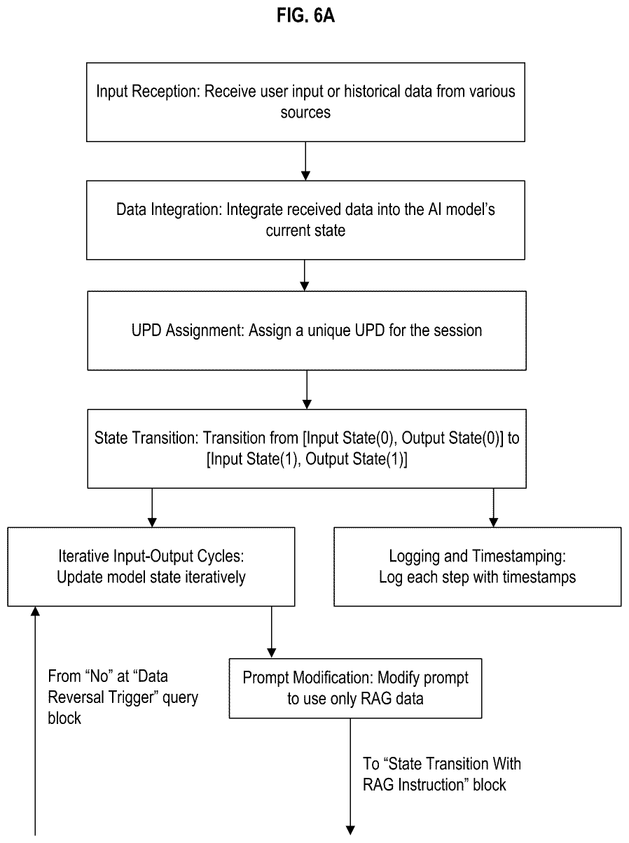

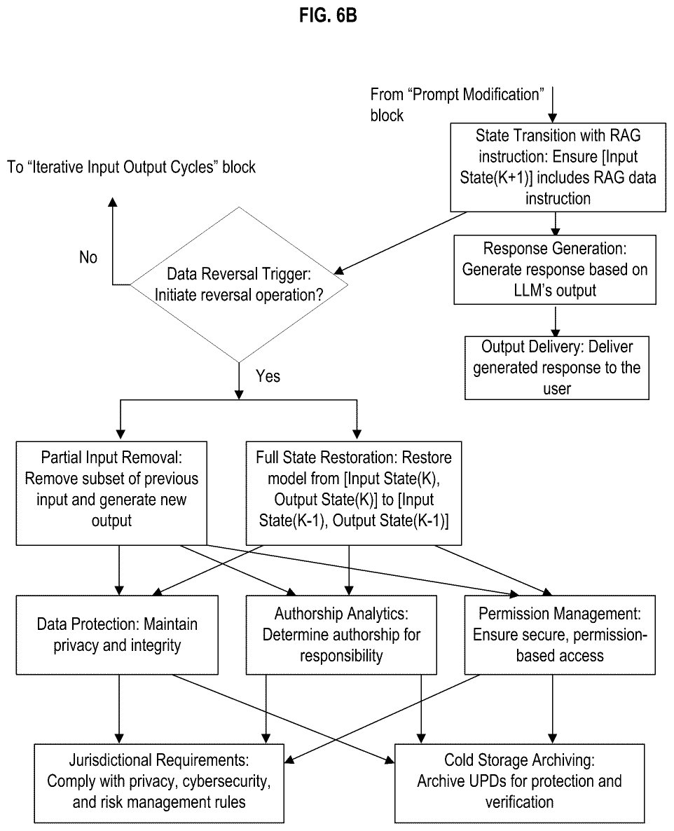

This process flow described immediately above is too large for one page, and thus it is presented in FIG. 6A, which is the beginning of it, and also in FIG. 6B, which is the second part of the process flow. Each of the blocks in FIGS. 6A and 6B, respectively track the bolded sub headings above. Not shown in the process flow of FIGS. 6A and 6B are “Instruct LLM to Use Only RAG Data” and “User Output.” However, as noted above, the “only use RAG data” instruction is shown in FIG. 3 at 350, the “User Output” is shown at FIG. 4 block 440 (Response generation), and also at FIG. 5, block 510 (Response delivery).

In embodiments, by including a step where the LLM is instructed to use only RAG data, it is ensured that the OpTel instrumentation of the RAG database can provide insights into the LLM's logic. This simplifies the scenario by focusing on a more transparent and traceable process.

Understanding UPDs and their Role in AIRBOX

Broadly speaking, in embodiments, a comprehensive logging tool for LLMs may be provided, placed in a very secure environment. In embodiments, Open Telemetry, for example, may be used to instrument running code. It is noted that, in some embodiments, existing python libraries may also be leveraged.

In embodiments, custom extensions may be created for use with Open Telemetry. As described in detail below, these custom extensions may include definitions of UPD, UPD Span, UPD Trace, and UPD Route, for example.

### 1. Universal Prompt Descriptor (UPD):

Definition: A UPD is a unique identifier for each prompt interaction with an LLM, capturing the essence of the prompt as a combination of vectors and metadata.

### Components:

Event-Triggered Time Code: Timestamp indicating when the UPD was generated.
Author ID Code (Anonymized): A 64-bit identifier for the author or owner that is anonymized by replacing the relevant bits with zeros.
Graph Vectors: A set of vectors from a graph database representing the semantic content and context of the prompt.
OpenTelemetry Data: Additional metadata like creation timestamps.
Sequence Designations: Indicates if the UPD is the first, last, or an interim node in a UPD ROUTE.

### 2. Role of Graph Databases:

Optimized for Connected Data: Graph databases excel at handling complex relationships between data points, making them ideal for managing the interconnected nature of UPDs and their evolution within UPD ROUTEs.
Recording UPD Vectors: They allow for efficient recording and querying of UPD vectors after-the-fact, enabling prompt optimization, debugging, and error repair without interrupting AIRBOX-native operations.
Defining UPDs in Vector Space: Graph databases make it trivial to define and calculate UPDs by identifying the apex of a set of vectors within the graph model.

### 3. Anonymization:

Exported UPDs: When UPDs are exported for use in any extra-AIRBOX environment, they are anonymized to protect internal data security.
Purpose of Anonymization: Beyond protecting customer data, anonymization ensures that the optimization process focuses solely on routing and minimizing computing resources without compromising sensitive information.
   4. UPD Routes and their Editability:
Definition: A UPD Route is a sequence of UPDs representing the path through vector space that leads to an output.
Editability: Unlike traditional LLMs, UPD ROUTEs can be edited like code in debuggers, allowing for optimization and replaying of pre-existing routes rather than generating new routes the database from scratch.
Benefits:
   Time and Power Savings: By reusing stored UPD sequences, significant computational effort and energy consumption can be saved.
   End-to-End Optimization: Entire UPD Routes can be optimized, enhancing the efficiency of LLM operations.

### 5. Research and Efficacy:

Potential Savings: The potential for significant time and energy savings is substantial, potentially allowing a single data center to perform the work of multiple centers.

In embodiments, UPDs and their associated ROUTEs represent an improved approach to managing LLM interactions. By leveraging graph databases and anonymization, these systems can optimize routing, minimize computational resources, and enhance efficiency. The editability of UPD ROUTEs introduces new possibilities for debugging, optimization, and the potential for significant reductions in energy consumption.

Enhanced Observability with OpenTelemetry Integration

In contemporary computing environments characterized by microservices, cloud-native architectures, and rapidly evolving business requirements, observability emerges as a critical enabler for understanding system behavior, diagnosing issues, and optimizing performance. The ability to gain insights into the intricate internal workings of systems is paramount, particularly in large-scale distributed applications.

OpenTelemetry serves as a pivotal observability framework, designed with extensibility and vendor-neutrality at its core. Unlike traditional observability backends like Jaeger or Prometheus, OpenTelemetry focuses on the generation, collection, management, and export of telemetry data such as traces, metrics, and logs. This differentiation allows organizations to maintain control over their data and integrate seamlessly with a variety of observability tools without lock-in.

One of the primary objectives of OpenTelemetry is to simplify the process of instrumenting applications across diverse languages, infrastructure, and runtime environments. By adhering to a single set of APIs and conventions, it reduces complexity for developers and IT teams, enabling them to adopt observability strategies more efficiently. This standardization ensures that telemetry data can be consistently captured, processed, and exported, regardless of the underlying technology stack.

Incorporating OpenTelemetry can significantly enhance the robustness of a system's observability capabilities. By leveraging OpenTelemetry's comprehensive suite of tools and frameworks, an example system may be instrumented effectively to capture detailed telemetry data. This integration not only facilitates enhanced diagnostics but also supports advanced analytics for performance optimization.

### Key Features of OpenTelemetry Integration:

### 1. Unified Telemetry Collection:

OpenTelemetry provides a unified mechanism for collecting traces, metrics, and logs from an application. This ensures that all relevant telemetry data is captured in a consistent format, simplifying the analysis process.

### 2. Vendor-Neutral Exporting:

With support for various observability backends, OpenTelemetry allows for the export of collected data to chosen platforms. Whether using cloud-based solutions or on-premises systems, this flexibility ensures that system telemetry data is stored and analyzed in the most suitable environment.

### 3. Automated Instrumentation:

OpenTelemetry's automatic instrumentation capabilities enable the capture of detailed traces without manual code modifications. This feature accelerates the deployment of observability features across different system components, enhancing efficiency and reducing operational overhead.

### 4. Extensible Framework:

The extensibility of OpenTelemetry allows for customization and integration with specialized tools or proprietary systems. This adaptability ensures that an observability strategy may be tailored to meet the unique needs of an application.

By implementing various AIRBOX embodiments using OpenTelemetry, cutting-edge observability practices may be leveraged. The capabilities provided by OpenTelemetry not only enhance the diagnostic and performance optimization aspects of a system but also contribute to its overall reliability and maintainability. This strategic integration underscores the advanced nature of a given solution in navigating the complexities of modern computing environments.

### Container in a Container

In embodiments, a part of the AIRBOX security strategy may be “container in a container.” This means that AIRBOX is broadly distributed as a Docker- or Kubernetes-style container depending on the scale of the installation. The container specification can vary, and the prototype used PodMan, a more secure container specification from Red Hat. Whatever container used must for security reasons be operated rootless, without requiring root privileges. When a non-root user initiates a container start, such containers fork and execute Rootless Containers: The fork-exec model allows containers to run without requiring root privileges. When a non-root user initiates a container start, the container forks and executes under the user's permissions.

Ideally the containers should also have a daemonless architecture. Unlike Docker, which requires a central daemon (dockerd) to create, run, and manage containers, the chosen container type should employ the fork-exec model. When a user requests to start a container, it should fork from the current process, then the child process execs into the container's runtime.

Having those container characteristics, AIRBOX consists of one container holding most of the application software components (LLMs, vector databases, comparators, etc. plus control logic), a second parallel container holds RAG databases and a graph database (the prototype used Nebula Graph) and a third parallel container holds the complete Open Telemetry application including its log database. All three of these containers are, in turn, contained within another container that exists entire for security purposes, providing that AIRGAP.

Container in a container is normally considered to be bad application design. However, in embodiments, because Open Telemetry components are continuously monitoring the systems looking for signs of pending malfunction, example applications may be repaired before they become truly unstable.

Next described is an example container in a container architecture overview, with additional implementation details, according to various embodiments.

### 1. Container Architecture Overview

Outermost Security Container:
   Purpose: Acts as an airgap, preventing unauthorized access or interference between components.
   Characteristics:
      Rootless operation to ensure no root privileges are required for container management. Daemonless architecture using the fork-exec model to enhance security by eliminating centralized daemon processes.
Application Container:
   Components: LLMs, vector databases, comparators, control logic, etc.
   Characteristics:
      Rootless operation to minimize attack vectors.
      Regularly updated and monitored for vulnerabilities.
RAG and Graph Database Container:
   Components: RAG (Retrieval-Augmented Generation) databases, Graph database (e.g., Nebula Graph).
   Characteristics:
      Secure communication with the application container using ZeroTier or WireGuard.
      Rootless operation to maintain security.
Open Telemetry Container:
   Components: Complete Open Telemetry stack, including log database.
   Characteristics:
      Continuously monitors system health and performance.
      Provides real-time insights for proactive maintenance and repair.

### 2. Communication Protocols

ZeroTier or WireGuard:
   Purpose: Ensures secure communication between containers and their associated applications.
   Characteristics:
      Ultra-secure protocols that encrypt data in transit.
      Minimal overhead, providing efficient communication channels.

### 3. Implementation Considerations

Rootless Containers: Fork-Exec Model
bash
#Example of starting a rootless container using Podman (PodMan is the prototype used)
#Start a non-root user session
$ podman run --user $(id -u):$(id -g) -it my-application-image
#Inside the container, the application runs under the user's permissions without requiring root access.

### Daemonless Architecture

bash
#Example of starting a container using the fork-exec model with Podman
#Start a container from a user session
$ podman run --user $(id -u):$(id -g) -it my-application-image/bin/bash
#Inside the container, the application forks and execs into its runtime environment.

### Container Communication Using ZeroTier or WireGuard

bash
#Example of setting up ZeroTier network for secure communication between containers
#Install ZeroTier on each node
$ curl -s https://install.zerotier.com|sudo bash
#Join a pre-existing ZeroTier network
$ zerotier-cli join <network-id>
#Configure firewall rules to allow only ZeroTier traffic

### 4. Monitoring and Maintenance

Open Telemetry:
Purpose: Continuously monitors the entire system for signs of malfunction.

### Example Implementation

bash
#Install OpenTelemetry agent in the Open Telemetry container
$ opentelemetry-collector --config=/path/to/config.yaml
#Configure the collector to send telemetry data to a centralized monitoring service or local dashboard.

### Automated Repair Mechanism:

Purpose: Detects and repairs issues before they become critical.

### Example Implementation

bash
#Example of an automated script that checks system health and restarts containers if necessary
#Monitor container status using a custom script or tool
$ ./monitor.sh
#Script example (simplified)
#!/bin/bash
while true; do
#Check if application container is running
if !podman inspect -f ‘{{.State.Status}}’ my-application-container|grep -q “running”; then
   echo “Application container not running, restarting . . . ”
   podman restart my-application-container
fi
#Sleep for a specified interval (e.g., 60 seconds)
sleep 60
done

### 5. Security Best Practices

Regular Updates: Ensure all containers and their components are regularly updated to patch vulnerabilities.
Least Privilege Principle: Run each container with the minimum necessary permissions.
Network Segmentation: Use ZeroTier or WireGuard to segment network traffic and limit exposure between containers.
Logging and Monitoring: Implement comprehensive logging and monitoring to detect and respond to security incidents promptly.

Thus, a “container in a container” design, combined with rootless operation, daemonless architecture, and ultra-secure communication protocols such as, for example, ZeroTier or WireGuard, may provide a robust security framework for AIRBOX. By leveraging these advanced containerization techniques and continuous monitoring, AIRBOX can maintain its integrity and ensure reliable operation even in complex environments.

### The Importance of Rag to AIRBOX

An ontology is a list or pile or container or bag of words available to be used in documents and speech. If we speak English our ontology is somewhere between the 200,000+ total unique words in the language and the 2000-3000 words used by most native English speakers. We get along perfectly fine in life using vocabularies that include less than one percent of the total words in our native language. Babies and toddlers have ontologies measured at perhaps a few dozen words yet nearly always get their way. For all these examples, the ontology is the total list of usable words.

A schema brings organization and individuation to an ontology. If you are a dentist your schema has those same 2000-3000 common words plus a few hundred more words about dentistry as a science and a profession. Every formal group of people has its own schema.

A knowledge graph is a picture of a schema at some fixed point in time. Such a knowledge graph includes all words of the ontology. The graphical organization of lines connecting those words represents the links within the ontology that define its schema.

All this comes from linguistics but hardly any of it even matters for Large Language Models because nobody really knows what is happening in those. So, when we write about OpTel spans and traces and nodes and about AIRBOX UDPs and UDP Routes, what the heck are we talking about? Training LLMs is a Dark Art and even fine-tuning LLMs is at best a nearsighted exercise in changing training data randomly until the right inputs somehow generate the right outputs. The LLM is a black box and nobody knows what's happening inside.

But there are ways to guess what's happening inside LLMs and presently the best of these come from RAG training. Retrieval-Augmented Generation (RAG) is the process of optimizing the output of a Large Language Model so it references an authoritative knowledge base outside of its training data before generating a response. The LLM, having been already trained on a huge ontology, uses a RAG database to learn knowledge that probably wasn't in the original training corpus, like who won last night's baseball game.

AIRBOX uses its RAG database in several ways. RETRORAG within AIRBOX is the best way to include in the AI customer data or any secure or confidential data. Going further, AIRBOX's RETRORAG can act as a proxy for its entire knowledge base. And by studying the OpTel-instrumented RAG Database operation, we can see how it works and can in turn guess what it infers for the LLM as a whole.

This embodiment both overcomes the limitations of LLM debugging and optimization and provides entirely new ways to represent knowledge. How is this done, though? LLMs know things, but for the most part they don't know how or why they know them. Many multi-lingual LLMs, for example, were never trained on foreign languages, they just picked them up—so-called emergent talents that came from nowhere as some side benefit of the LLM's original training.

There is no reason to expect that a RAG database referenced by an LLM would be used any differently than would that LLM's internal knowledge that cannot be seen or measured. All that is needed to do is make the RAG database do all the work for the LLM, which in this instance becomes simply a writing or talking machine with no addressable knowledge of the world. That is in the text of the prompt used to test this concept: “use only knowledge from the RAG database, ignoring completely your earlier training except for the purposes of expression.”

That is, effectively, telling a $100 million LLM to turn off its brain, which it can easily do, yet prior to AIRBOX nobody seems to have tried.

Imagine, therefore, using AIRBOX not in a production environment but for software development. By replacing most of the LLM training data with much less RAG data that is still subject to LLM logic, in embodiments, through OpTel observation and logging, it can be determined what is happening in the neural net. A-B testing may be performed with full LLMs, using chunking and embedding, and with different types of databases. The tasks are easier and less mysterious because the data is knowable—a revolutionary embodiment.

Such RAG analysis is perfectly analogous to the 2000-3000 word practical ontologies that most of us use very well. An LLM's original training shows it how to think and speak (the actually hard parts) but then practical knowledge is drawn experimentally from the RAG database which is small enough to be understood. If a process is halted, or an outcome reversed, this is done in the RAG database—at least for now. That capability is unique to AIRBOX.

### UPD Related Exemplary Code Snippets

The following code snippets provide a foundational implementation for managing UPDs and their routes, along with error handling and real-time adaptation capabilities, in accordance with various embodiments. In embodiments, these examples may be further expanded to include more sophisticated error detection mechanisms, dynamic context management, and detailed Logging/tracing using OpenTelemetry.

```
1. Defining UPDs
python
class UniversalPromptDescriptor:
  def init(self, id, attributes):
    self.id = id
    self.attributes = attributes # Dictionary of attributes
  def update_attribute(self, key, value):
    self.attributes[key] = value
# Example UPD creation
upd1 = UniversalPromptDescriptor(id=1, attributes={“function”: “WORD * NUM + WORD
* NUM”, “sub_word_analysis”: True})
2. Managing UPD Routes
python
class UPDRoutes:
  def init(self):
    self.routes = [ ]
  def add_route(self, route):
    self.routes.append(route)
  def get_route_by_id(self, id):
    for route in self.routes:
      if route.id == id:
        return route
    return None
# Example of adding and retrieving routes
upd_routes = UPDRoutes( )
upd_routes.add_route(upd1)
retrieved_upd = upd_routes.get_route_by_id(1)
3. Error Detection and Correction
python
class ErrorHandler:
  def detect_error(self, route):
    # Simple error detection logic (e.g., missing attributes)
    if “function” not in route.attributes:
      return True
    return False
  def correct_error(self, route): # Correct the error by updating the missing attribute
  route.update_attribute(“function”, “WORD * NUM + WORD * NUM”)
# Example of error handling
error_handler = ErrorHandler( )
if error_handler.detect_error(retrieved_upd):
  print(“Error detected in UPD Route 1.”)
  error_handler.correct_error(retrieved_upd)
  print(“Error corrected.”)
4. Real-Time Adaptation
python
class ContextManager:
  def init(self, current_context):
    self.current_context = current_context
  def update_context(self, new_context):
          # Update context based on user feedback or changes in the environment
    self.current_context = new_context
# Example of updating context
context_manager = ContextManager(current_context={“user_preference”: “formal”})
context_manager.update_context(new_context={“user_preference”: “informal”})
5. Pseudocode for a Complete Process
plaintext
1. Initialize UPDRoutes and ErrorHandler objects.
2. Define initial UniversalPromptDescriptors with their attributes.
3. Add these descriptors to the UPDRoutes object.
  For each route in UPDRoutes:
    4. Detect any errors using ErrorHandler.
    5. If error is detected, correct it using ErrorHandler.
6. Retrieve a specific UPD Route by its ID and use it for processing.
7. Update the context dynamically based on user feedback or environmental changes.
8. Repeat steps 4-7 as necessary to refine and adapt the process in real-time.
6. Example Integration with OpenTelemetry
python
import opentelemetry.trace as trace
tracer = trace.get_tracer(name)
@tracer.start_as_current_span(“process_UPD”)
def process_UPD(route):
            # Simulate processing using UPD attributes
  if “function” in route.attributes:
    print(f”Processing with function: {route.attributes[‘function’]}”)
  else:
    print(“Function attribute missing. Skipping processing.”)
# Example of tracing the UPD processing step
process_UPD(retrieved_upd)
```

### Further Uses for UPDs and UPD Routes

As described above, in embodiments, UPDs and UPD routes may be used to expedite retracing paths, or reverting to earlier points in a path, within a database. In embodiments, these constructs may also be leveraged for various other functions, as described below.

### 1. Debugging and Error Correction

Iterative Refinement: Developers can iteratively refine the UPD Routes by identifying and correcting errors at specific points in the sequence. This allows for continuous improvement without starting from scratch.
Automated Error Detection: Implement machine learning models to automatically detect anomalies or errors within UPDs, enabling real-time corrections.

### 2. Personalization and Customization

User-Specific Paths: Tailor the UPD Routes based on user preferences, history, or context to provide more personalized, or specifically filtered, responses and interactions.
Adaptive Learning Systems: Use historical UPD data to adaptively learn and modify paths over time, enhancing the AI system's ability to understand and respond to unique user needs.

### 3. Optimization of Computational Resources

Efficient Query Processing: By identifying redundant or unnecessary steps in UPDs and UPD Routes, computational resources may be optimized, leading to faster response times and reduced costs.
Resource Allocation: Dynamically allocate resources based on the complexity and importance of different parts of UPD Routes, ensuring efficient use of hardware.

### 4. Security Enhancements

Data Isolation: Implement data isolation techniques by controlling the flow of information through specific UPDs, preventing unauthorized access or data leakage.
Access Control: Use UPDs to enforce strict access controls, allowing only authorized users to modify or view certain parts of the session history.

### 5. Version Control and Replicability

Version Management: Maintain version control for different iterations of UPD Routes, enabling easy rollback or comparison between versions.
Consistent Results: Ensure replicable results by defining clear and consistent UPD paths for specific tasks, reducing variability in outputs.

### 6. Explainability and Transparency

Auditable Trails: Create auditable trails of UPD modifications, providing transparency into the AI system's decision-making process.
User Education: Use UPDs to explain the reasoning behind specific outputs, helping users understand how the AI system arrived at a particular conclusion.

### 7. Hybrid Systems Integration

Interoperability with Other Tools: Integrate UPD tracking with other development and monitoring tools, thereby enhancing the overall workflow and reducing integration challenges.
Cross-AI System Coordination: Coordinate between different AI systems or components by aligning their UPD Routes, ensuring seamless interaction and collaboration.

### 8. Experimentation and A/B Testing

Variational Paths: Design variational paths within UPDs to test different approaches or hypotheses without affecting the main workflow.
Performance Metrics: Collect metrics on various UPD Routes to evaluate and optimize performance, leading to data-driven improvements.

### 9. Content Management and Governance

Content Versioning: Implement content versioning using UPD Routes to manage updates and changes to generated content effectively.
Policy Enforcement: Use UPDs to enforce specific policies or guidelines during the generation process, ensuring compliance with organizational standards.

### 10. Real-Time Adaptation

Dynamic Adjustments: Allow real-time adjustments to UPD Routes based on user feedback or changing context, enabling the AI to adapt quickly and effectively.
Contextual Awareness: Enhance contextual awareness by dynamically updating UPDs in response to new information or changes in the environment.

In embodiments, by leveraging these example additional uses of UPDs, the capabilities and effectiveness of Generative AI systems may be significantly enhanced. In embodiments, such a holistic approach not only addresses current challenges but also opens up new possibilities for innovation and improvement in the field.

Encoding UPDs with OpenTelemetry

Next described are exemplary embodiments that implement UPD encoding using OpenTelemtery.

```
1. Data Structure Definition
        Prompt Metadata: Include essential metadata such as:
            user_id: Unique identifier for the user.
            timestamp: The exact time when the prompt was received.
            sequence_id: A unique identifier for the sequence of UPDs, ensuring
            continuity.
            function_applied: The specific function or model used to process the
            prompt (e.g., GPT-4).
            datastream_type: Type of data involved (e.g., text, image).
        Prompt Content: Encode the actual content of the prompt in a secure and
        traceable manner.
2. Encoding Scheme
JSON Format: In embodiments, JSON may be used to structure the UPD metadata for
easy parsing and integration with OpenTelemetry.
json
{
  “user_id”: “12345”,
  “timestamp”: “2023-10-01T12:00:00Z”,
  “sequence_id”: “67890”,
  “function_applied”: “GPT-4”,
  “datastream_type”: “text”,
  “prompt_content”: “Provide a summary of the document.”
}
Base64 Encoding: Encode the prompt_content field (shown above) using Base64 to
ensure that sensitive data is handled securely and can be transmitted without issues.
json
{
  “user_id”: “12345”,
  “timestamp”: “2023-10-01T12:00:00Z”,
  “sequence_id”: “67890”,
  “function_applied”: “GPT-4”,
  “datastream_type”: “text”,
  “prompt_content”: “UHJvdmlkZSBhIHN1bW1hbGxlciBvZiB0aGUgZG9jdW1lbnQu”
}
3. OpenTelemetry Integration
        Trace Context: Use OpenTelemetry's trace context to link multiple UPDs within
        the same sequence.
python
from opentelemetry import trace
tracer = trace.get_tracer_provider( ).get_tracer(name)
with tracer.start_as_current_span(“UPD_Sequence”) as span:
    span.set_attribute(“user_id”, “12345”)
    span.set_attribute(“sequence_id”, “67890”)
    # Process each UPD in the sequence
    for upd in upds:
      with tracer.start_as_current_span(f“UPD_{upd[‘sequence_id’]}”) as upd_span:
          upd_span.set_attributes({
          “timestamp”: upd[“timestamp”],
          “function_applied”: upd[“function_applied”],
          “datastream_type”: upd[“datastream_type”]
          })
```

### 4. Security Considerations

Encryption: Encrypt sensitive data at rest and in transit using industry-standard encryption protocols (e.g., AES-256) before encoding.
Access Control: Ensure that only authorized users can access or modify the UPD logs.

As illustrated in the above examples, by structuring UPDs using a clear JSON format, encoding sensitive content with Base64, and integrating them into OpenTelemetry's trace context, a robust and secure logging system may be achieved. This approach ensures that each UPD is traceable, secure, and compliant with necessary standards, making it suitable, for example, for internal monitoring.

Conditional Span Creation with UPDs

In embodiments, it is useful to create spans (tracing segments) that start at one UPD event and end at the next. In embodiments, this allows for tracing the flow of prompts through a system, ensuring that each span captures a complete interaction or task defined by these descriptors.

### Exemplary Implementation Steps

1. Initialize Tracer Provider: Set up OpenTelemetry to capture traces.
2. Create a Decorator for UPD Events: Define a decorator that starts and ends spans based on UPD events.
3. Instrument Code: Apply this decorator to functions or methods that handle UPD events.

Example Implementation Example Using OpenTelemetry in Python:

```
python
from otel_extensions import init_telemetry_provider, get_tracer
import logging
init_telemetry_provider( ) # Initialize the tracer provider
      # Create a custom decorator for conditional span creation based on UPD events
def upd_span_decorator(func):
  def wrapper(*args, **kwargs):
    # Start a new span when encountering a UPD event
    with get_tracer(name).start_as_current_span(“UPD Span”) as span:
        result = func(*args, **kwargs)
        return result
  return wrapper
          # Apply the decorator to functions that handle UPD events
@upd_span_decorator
def process_upd_event(data):
          # Process the UPD event
  logging.info(f“Processing UPD event: {data}”)
  return f“Processed data: {data}”
          # Example usage
if name == “main”: logging.basicConfig(level=logging.INFO)
          # Simulate a sequence of UPD events
  upd_events = [
    {“type”: “UPD”, “content”: “Generate report on Q4 sales”},
    {“type”: “UPD”, “content”: “Summarize findings from the generated report”},
    {“type”: “UPD”, “content”: “Provide recommendations based on the summary”}
  ]
  for event in upd_events:
    if event[“type”] == “UPD”:
        process_upd_event(event[“content”])
```

### Explanatory Notes

### 1. Tracer Initialization:

init_telemetry_provider( ): Sets up OpenTelemetry to capture and export traces.
   2. Custom Decorator (upd_span_decorator):
This decorator wraps functions that handle UPD events. It starts a new span when a UPD event is encountered, ensuring that each span encapsulates the processing of one complete UPD event.

### 3. Instrumented Function:

process_upd_event(data): The function processes each UPD event. By applying the decorator to this function, it is ensured that every call generates a corresponding trace span.

### 4. Simulated UPD Events:

A list of UPD events is simulated, and the decorated function is called for each event.

### Benefits:

Traceability: Each UPD event is captured in its own span, making it easy to trace the flow of prompts through your system.
Consistency: By using a consistent naming convention (“UPD Span”), it is ensured that all spans related to UPD events are easily identifiable.
Debugging and Monitoring: With these detailed traces, the behavior of a given application may be better understood, bottlenecks identified, or issues related to prompt processing debugged.

### Further Customization

In some embodiments, exemplary implementations may be further enhanced as follows:
Attributes: Attributes added to spans to capture more context (e.g., event type, content).
Span Naming: Dynamically name spans based on the content of the UPD events for better clarity.
Error Handling: Capture exceptions within spans to track failures related to specific UPD events.

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

### EXAMPLES

In a first example, a replicable and attributable AI framework ecosystem may be implemented.

In a second example, a set of processes, methods and apparatuses for secure, time-stamped, permission-based, segregated, reversible, private and community, machine learning artificial intelligence implementations, platforms and frameworks may be provided.

In a third example, a process may include a series of discrete sessions, each with their own UPD, that allows each AIRBOX session to be reconstituted, in its exact state, at any point in the future.

In a fourth example, the AI framework ecosystem of the first example is further configured to provide a measurable level of cybersecurity to AI through its iPaaS architecture, interconnections, with inherited controls, to the CLASsoft™ PaaS with FedRAMP/NIST 800-35 (Rev 4) credentials and inherited controls from AWS as IaaS.

In a fifth example, the AI framework ecosystem of the first example, is further configured to the appropriate jurisdiction's rules and requirements re privacy, cybersecurity, operations, and risk.

In a sixth example, the AI framework ecosystem of the first example is further configured such that changes, additions, and deletions of data in LLMs and associated databases may be reversed. This represents the first real instance of two-way AI development, where normally change can only happen in a single direction.

In a seventh example, the AI framework ecosystem of the first example, is further configured to reverse by stage (by Data Lake state)—a single reversal, and the ability to reverse to state zero.

In an eighth example, the AI framework ecosystem of the first example, is further configured to include timestamped logging, and further configured, through AIRBOX, analytics, to determine authorship, and assign and limit responsibility.

In a ninth example, the AI framework ecosystem of the first example, is further configured to one or more of:
bring a mature version of privacy to Generative AI where personal data can be excluded, included, removed, or highlighted as needed and privacy laws can be enforced; ensure IP stability for all parties is ensured, whether Open Source or Closed Source data is used; enable parties who spend millions creating data sets to have confidence that their data is safe inside AIRBOX, and that it can also be traced and recovered if it escapes or is stolen—this through data fingerprinting that's innate to AIRBOX; and enable archiving UPDs in Cold Storage to protect from bad actors, create an evidential trail of custody, and enable instant and regular identification of corrupted or altered UPDs through their changed checksums allowing quick interaction detection and isolation.

In a tenth example, a reliability engine is provided. The engine is configured to test the consistency of an AI model as it moves forward and backward through the generative process.

In an eleventh example, an attributable and time-stamped session engine is provided. The session engine is configured to assign and manage AI model input and output responsibility and ownership. The session engine is further configured to generate an evidentiary record of who did what, and from where and when.

In a twelfth example, a protection engine is provided, the protection engine configured to keep time-stamped records of the data from going in and out of the LLM, and in turn keep any data from migrating upstream to the LLM vendor. The engine is further configured to forensically ascertain both actions and responsibilities of involved parties.

In a thirteenth example, a secure co-operative writing engine is provided. The engine is configured to discern who wrote what (or provided the inputs for what, given this AI) as practically to disassemble the product for any reason. The engine is further configured to banish (or truly retire) a bad actor from a co-authored or multi-authored literary or scientific manuscript endeavor.

What is claimed:

1. An AI framework ecosystem configured for secure, time-stamped, permission-based access, comprising:
a sessions manager, configured to run a series of discrete sessions, each session associated with a unique Universal Prompt Descriptor (UPD);
a reconstruction engine, configured to reconstruct any of the discrete sessions at any subsequent time;
a timestamp logger to record activities within the framework; and
an analytics engine configured to determine authorship and assign responsibility based on the logged data.

2. The AI framework ecosystem of claim 1, further comprising:
a protection engine configured to keep time-stamped records of data entering and exiting a large language model (LLM), and prevent any data from migrating upstream to an LLM vendor; and
a forensic analyzer to ascertain actions and responsibilities of involved parties.

3. The AI framework ecosystem of claim 2, wherein the forensic analyzer is integrated within the protection engine.

4. The AI framework ecosystem of claim 1, wherein each session is configured with reversible changes in associated data.

5. The AI framework ecosystem of claim 4, wherein the sessions manager is further configured to use the reversible changes to allow additions, deletions, and modifications to the session so as to reverse the session to any previous state.

6. The AI framework ecosystem of claim 5, wherein the previous state is a zero state of the session.

7. The AI framework ecosystem of claim 1, further comprising:
a secure co-operative writing engine configured to discern the contributions of multiple authors; and
a banning engine, configured to ban a bad actor from a collaborative manuscript effort based on forensic analysis.

8. The AI framework ecosystem of claim 1, further comprising a reliability engine configured to test consistency of an AI model as it progresses through generative processes in both forward and backward directions.

9. The AI framework ecosystem of claim 1, further comprising:
an attributable and time-stamped session engine configured to manage input and output responsibility and ownership;
an evidentiary record generator, configured to detail actions performed by whom, from where, and when.

10. The AI framework ecosystem of claim 1, wherein the framework is configured to archive UPDs in Cold Storage for protection against bad actors, create an evidential trail of custody, and enable quick detection and isolation of altered UPDs through checksum verification.

11. An AI framework ecosystem configured to provide a measurable level of cybersecurity, comprising:
an iPaaS architecture interconnected with CLASsoft™ PaaS having FedRAMP/NIST 800-35 (Rev 4) credentials and inherited controls from AWS as IaaS; and
a secure, time-stamped, permission-based environment for machine learning AI implementations.

12. The AI framework ecosystem of claim 11, further configured to comply with jurisdictional rules and requirements related to privacy, cybersecurity, operations, and risk management.

13. The AI framework ecosystem of claim 1, further comprising:
a secure co-operative writing engine configured to discern contributions from multiple authors; and
a forensic analyzer configured to determine actions and responsibilities of users in collaborative efforts.
